(19) United States
(12) Patent Application Publication
(10) Pub. No.: US 2007/0276910 A1
(43) Pub. Date: Nov. 29, 2007

(54) Conferencing system with desktop sharing

(76) Inventors: Scott Deboy, Hillsboro, OR (US); Kenneth Majors, Lake Oswego, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/805,651

(22) Filed: May 23, 2007

Related U.S. Application Data
(60) Provisional application No. 60/808,031, filed on May 23, 2006.

(51) Int. Cl. G06F 15/16

(52) U.S. Cl. 709/204

(57) ABSTRACT

A system that facilitates the sharing of a computer desktop among a plurality of users.

### CROSS-REFERENCE TO RELATED APPLICATIONS

This application claims the benefit of U.S. Provisional App. No. 60/808,031, filed May 23, 2006.

### BACKGROUND OF THE INVENTION

A system that facilitates the sharing of a computer desktop among a plurality of users.

Multiple users of the same computer, such as a computer running Windows XP, may gather around the monitor and observe what is being presented. In this manner a group of users may view the same event at the same time presented on the computer desktop.

Multiple users may access the same computer desktop using multiple computers interconnected to a computer network. Typically the users connect to the desired desktop in some fashion and may observe what is occurring on the computer desktop. This permits the users to be remotely located from the computer while still being able to observe the events being presented on the computer desktop.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a conferencing system.

FIG. 2 illustrates another conferencing system.

FIG. 3 illustrates a conferencing server.

### DETAILED DESCRIPTION OF PREFERRED EMBODIMENT

In a computer based conferencing environment, there may be multiple users sharing information and discussing items using a joint audio conferencing, joint video conferencing, and/or joint document sharing system. The audio conferencing enables multiple users to simultaneously discuss things in an effective manner. The video conferencing enables multiple users to simultaneously view each other which is helpful to convey ideas to one another. The joint document sharing system permits different users to simultaneously view electronic documents that are being edited or otherwise being modified.

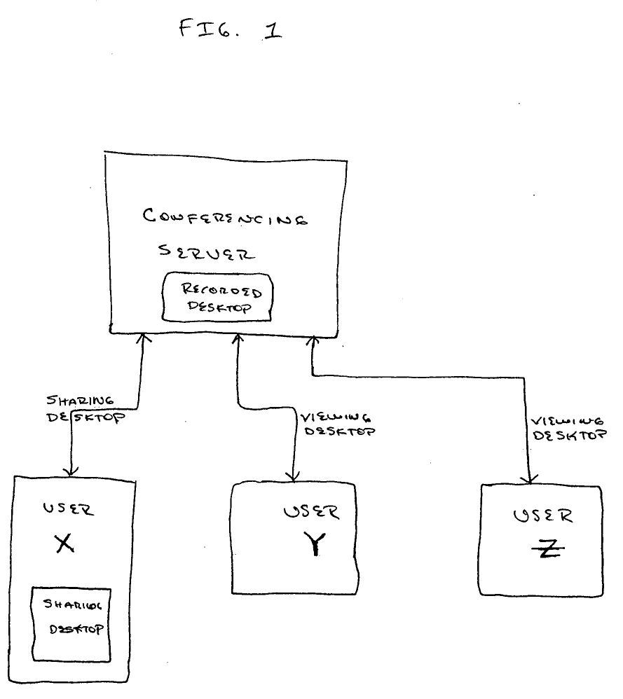

Referring to FIG. 1, in many cases a user in a conference has a desktop (or otherwise a screen image) on his computer that he may share the desktop with other people. In this manner, multiple viewers may observe the changes made to the desktop by the user. For example, the user may show others how to draw a picture, present a power point presentation, illustrate changes made to documents, or otherwise illustrate useful information. Typically, the user of the desktop being shared has control over the desktop upon moving the mouse or otherwise desiring to interact with the desktop. The control over the desktop may be passed to another user, as desired, using any suitable mechanism. Accordingly, the user may present the desktop to others to view, or otherwise share the use of the desktop among others while permitting them to view the desktop.

While the presentation and/or sharing of the desktop is especially beneficial for users of the system that are present, it has limitations when other users want to review what occurred during a previous conference they were unable to attend or view. In order to provide users with the ability to observe what previously occurred, the system may permit the user to record his desktop in the form of a sequence of images, such as a video sequence. Typically a video sequence has a frame rate of 30 to 60 frames per second. However, faster or slower frame rates may be used.

In the conferencing environment shown in FIG. 1, the conferencing server may be used to record the shared desktop. An installed application on the user x's computer (e.g., shared desktop) may obtain an image of the shared desktop on a periodic basis, such as 30 frames per second. Preferably the captured frame rate is less than 50/60 frames per second because typically the information in conferencing situations tends to change at a relatively slow rate, except for when video is being shared on the desktop. The system may use an adaptive technique, such that when video is being displayed on the shared desktop a higher frame rate is used, as opposed to when video is not being displayed on the desktop. Depending on the type of content being displayed, or otherwise the motion detected on the desktop, may be used as a basis for selecting a frame rate. In this manner, the system may more efficiently record the desktop, with the higher frame rate when higher motion is occurring, and the lower frame rate when lower motion is occurring. The resulting video sequence of the shared desktop is preferably obtained by and saved by the conferencing server. Alternatively, the shared desktop may be obtained and stored by the user x sharing the desktop. w

After recording a sequence of frames they may be played back upon demand to a user. However, if the capture rate is not temporally uniform, the information presented during the playback tends to be jerky or otherwise presents discontinuous video sequences. Also, if the capture rate is uniform but played back at a rate different than the capture rate, then the sequence may be difficult to view. Also, if frames are missed during capture or playback, then there tends to be discontinuities in the presentation.

In addition to saving a sequence of frames of the shared desktop, the system also preferably time stamps each of the frames in a suitable manner. For example, each of the frames of the shared desktop may be numbered in a sequential manner with a known timing between the frames. For example, each of the frames of the shared desktop may be encoded with SMTPE or MPEG-2 time stamps. Moreover, the frames are preferably encoded with motion based compression in order to significantly reduce the size of the resulting video sequence, because in many cases most of the desktop will not include significant motion. In addition, the frames may have a variable frame rate, typically depending upon the detected motion on the shared desktop. Moreover, the entire desktop, a portion of the desktop, or selected windows on the desktop may be recorded, as desired.

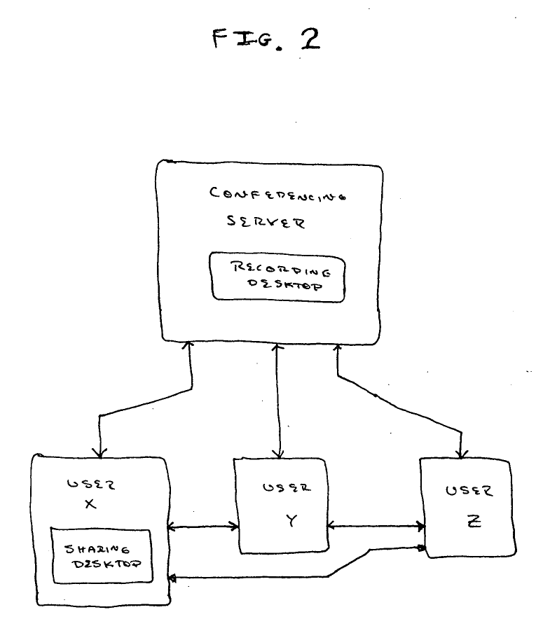

Referring to FIG. 2, the conferencing system may likewise permit the users to interconnect through the conferencing server and also to communicate among one another using a peer-to-peer type interconnection. In this manner, some of the data traffic that would otherwise be passed through the conferencing server is passed among the users. In this environment, the conferencing server may record the shared desktop or otherwise the user may record the shared desktop. In the event that the user records the shared desktop, the resulting file may be transferred to the conferencing server for later use.

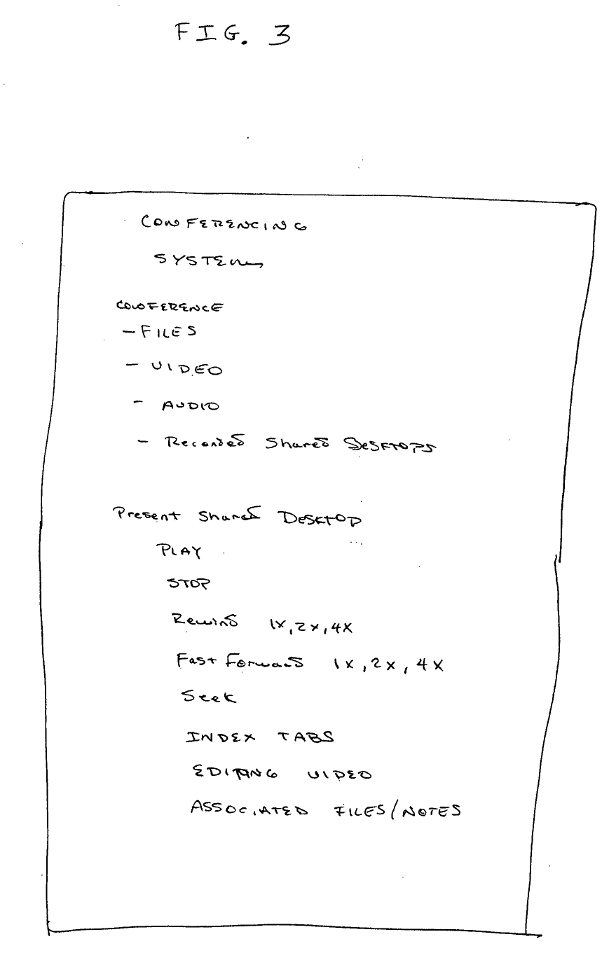

A user may subsequently access the conferencing system (or files on the computer of the user recording the desktop). Referring to FIG. 3, if the user has permissions to view files or other documents for the conference that was previously recorded for a particular shared desktop session, then the user may access the previously recorded desktop session. Since the desktop session includes time codes, the server may present the video of the shared desktop session with video control functions. For example, some of the video control functions may include, play, stop, rewind (multiple speeds), fast forward (multiple speeds), seek, index tabs. Moreover, the server may permit the user to edit the video.

The conferencing server may likewise include associated files, notes, audio, video, or other content associated with the recorded shared desktop. In this manner, in the event there were associated files with the recorded shared desktop, then the user would also be aware of these files and they would be presented to the user. In addition, the editing system may permit the user to link a file to the recorded desktop, and in particular, to a particular location within the recorded desktop. Also, the recorded desktop session may be linked to external references, as desired. Accordingly, the user may view the external references while playing the recorded desktop; or the user may view the appropriate location of the recorded desktop while viewing associated files.

The system may also permit different users to record the desktop session, or otherwise multiple users to record the same or different parts of a desktop session. In this manner, user can both view and record the desktop sessions. Among the users, the conferencing system may coordinate the recording of the session, such that one or more users has permissions to record the desktop. Preferably, only one user records a particular desktop session, and preferably that session is saved on the conferencing server.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A conferencing system:
(a) a conferencing server;
(b) a first computer accessing said conferencing server;
(c) a second computer accessing said conferencing server;
(d) at least one of said conferencing server, said first computer, and said second computer displaying a sequence of images on an associated display;
(e) at least one of said conferencing server, said first computer, and said second computer saving said sequence of images displayed on said display;
(f) said sequence of images including an associated temporal identifier such that said sequence of images may be rendered in a temporally controlled manner.

2. The system of claim 1 wherein said sequence of images includes associated audio.

3. The system of claim 1 wherein said sequence of images includes editing of documents.

4. The system of claim 1 wherein said first computer and said second computer simultaneously display said sequence of images.

5. The system of claim 1 wherein at least one of said conferencing server; said first computer, and said second computer renders said sequence of said images as a video sequence based upon said associated temporal identifier.

6. The system of claim 5 wherein said associated temporal identifier includes time stamps.

7. The system of claim 6 wherein said time stamps are MPEG-2 time stamps.

8. The system of claim 1 wherein said sequence of images have a variable frame rate depending upon the said sequence of images being displayed on said display.

9. The system of claim 8 wherein said variable frame rate is motion dependent.

10. The system of claim 1 wherein said first computer and said second computer communicate using a peer-to-peer technique.

11. The system of claim 1 wherein said first computer saves said sequence of images.

12. The system of claim 1 wherein said conferencing server saves said sequence of images.
